(19) United States
(12) Patent Application Publication
(10) Pub. No.: US 2025/0384766 A1
(43) Pub. Date: Dec. 18, 2025

(54) SYSTEMS AND VEHICLES

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 19/239,539

(22) Filed: Jun. 16, 2025

(30) Foreign Application Priority Data
Jun. 17, 2024 (JP) 2024-097687

(51) Int. Cl. G08G 1/0967; B60K 35/28; B60W 50/14; H04W 4/46

(52) U.S. Cl. CPC G08G 1/096783; B60K 35/28; B60W 50/14; H04W 4/46; B60K 2360/1868; B60K 2360/188; B60K 2360/5915; B60W 2050/146; B60W 2555/20; B60W 2556/65

(57) ABSTRACT

A system comprises a controller executing: when it is determined that the visibility around the first vehicle is poor, acquiring, from the mobile communication terminal of the first vehicle, travel position information indicating a position in which the first vehicle is traveling and peripheral vehicle information that is information on one or more second vehicles traveling around the first vehicle; extracting a first video that is a video that corresponds to a position indicated by the travel position information among the road video captured when the visibility is good that have been acquired in advance; and transmitting the extracted first video and the vehicle video that is superimposed on the first video and is a video depicting the second vehicle generated based on the peripheral vehicle information to the mobile communication terminal of the first vehicle.

### CROSS REFERENCE TO THE RELATED APPLICATION

This application claims the benefit of Japanese Patent Application No. 2024-097687, filed on Jun. 17, 2024, which is hereby incorporated by reference herein in its entirety.

### BACKGROUND

### Technical Field

The present disclosure relates to driver assistance of a vehicle.

### Description of Related Art

There is a technology to provide assistance in viewing surrounding vehicles and obstacles during vehicle operation. In this regard, for example, Japanese Patent Laid-Open 2000-184368 discloses a sensor signal superimposed on an in-vehicle camera system that displays information of an obstacle detected by the sensor in a graphic format and superimposed on a video signal of the in-vehicle camera. Japanese Patent Laid-Open 2017-21546 and Japanese Patent Laid-Open 1998-129375 are also disclose related arts.

### SUMMARY

The present disclosure is aimed at assisting a user to recognize surrounding vehicles in the same way as when visibility is good even if visibility is poor.

One aspect of the present disclosure relates to
a system comprising a controller comprising at least one processor configured to perform: when it is determined that visibility around a first vehicle is poor, acquiring, from a mobile communication terminal of the first vehicle, travel position information indicating a position in which the first vehicle is traveling and peripheral vehicle information that is information on one or more second vehicles traveling around the first vehicle; extracting a first video that is a video that corresponds to a position indicated by the travel position information among road video captured when the visibility is good that have been acquired in advance; and transmitting the extracted first video and a vehicle video that is superimposed on the first video and is a video depicting the second vehicle generated based on peripheral vehicle information to the mobile communication terminal of the first vehicle.

Further, another aspect of the present disclosure is
a vehicle comprising a display and a controller comprising at least one processor configured to perform: transmitting, to a core network, travel position information that is information on a travel position of a first vehicle and peripheral vehicle information that is information on one or more second vehicles traveling around the first vehicle; acquiring, from the core network, a first video that is a video corresponding to a position indicated by the travel position information extracted from road video captured when visibility is good and a vehicle video that is a video depicting the second vehicle and generated based on a peripheral vehicle information; and causing display unit to display the vehicle video with superimposed on the first video.

Another aspect includes a program for causing a computer to execute an information processing method executed by the system and the vehicle, or a computer-readable storage medium in which the program is stored non-transitorily.

According to the present disclosure, when visibility is poor, it is possible to provide assistance to a user so as to recognize surrounding vehicles in the same way as when visibility is good.

### BRIEF DESCRIPTION OF THE DRAWINGS

FIGS. 1A to 1B illustrate processing of acquiring a road video and providing a first video and a vehicle video by the server apparatus according to an aspect of the present disclosure.

FIG. 2 illustrates the components of the server apparatus and the vehicle according to the first embodiment.

FIG. 3 illustrates a sequence diagram of processing of acquisition of road video performed by the server apparatus according to the first embodiment.

FIG. 4 illustrates a sequence diagram of the processing of providing road video and vehicle video performed by the server apparatus according to the first embodiment.

FIGS. 5A to 5B illustrate an example of a field of view when visibility is poor and an example of a screen on which a vehicle video is superimposed on the road video.

FIG. 6 illustrates a component of the system according to the second embodiment.

### DESCRIPTION OF THE EMBODIMENTS

### Overview

A vehicle and an in-vehicle device are known for displaying graphical images relating to obstacles existing on a road while the vehicle is traveling, superimposed on images captured by an in-vehicle camera.

For example, the in-vehicle device may display graphical images indicating information of an obstacle (e.g., distance, direction, size, etc.) detected by a predetermined sensor provided by the vehicle, superimposed on images captured by the in-vehicle camera. Further, when visibility is poor, such as when fog or heavy rain occurs, or when lightness is low at night, the device can detect objects around the vehicle by an infrared sensor and an infrared camera and display the result on the screen.

However, even if obstacles are indicated by graphics, etc., there is a risk that the safety of driving the vehicle will be impacted if the same visibility as when visibility is good is not ensured overall. Further, when the image captured by the infrared camera is presented to the user, the image itself captured by the infrared camera may cause a sense of incongruity to the user.

In order to solve such a problem, it is preferable for the in-vehicle device to display a video representing an object around the vehicle in an intuitively recognizable manner superimposed on a road video taken in advance when visibility is good. For example, the above problem may be solved by displaying a video representing the appearance of the vehicle traveling in the vicinity detected by the vehicle in a manner that is superimposed on the video captured by the vehicle camera in advance.

A system according to one aspect of the present disclosure is
a system comprising a controller comprising at least one processor configured to perform: when it is determined that visibility around a first vehicle is poor, acquiring, from a mobile communication terminal of the first vehicle, travel position information indicating a position in which the first vehicle is traveling and peripheral vehicle information that is information on one or more second vehicles traveling around the first vehicle; extracting a first video that is a video that corresponds to a position indicated by the travel position information among the road video captured when the visibility is good that have been acquired in advance; and transmitting the extracted first video and a vehicle video that is superimposed on the first video and is a video depicting the second vehicle generated based on peripheral vehicle information to the mobile communication terminal of the first vehicle.

The first vehicle is a vehicle that is traveling on a road or the like and receives a service to provide video by the system. Here, the video provision service is a service that provides a video to make it easier to recognize the surrounding situation to the user when the visibility around the vehicle being driven by the user is poor. The first vehicle is equipped with a mobile communication terminal and is capable of communicating with the core network.

Poor visibility refers to, for example, fog pouring into the periphery of the first vehicle making it difficult to see the surrounding object, or insufficient brightness of the surroundings at night or the like makes it difficult to see the surrounding object.

The travel position information is information indicating a position where the first vehicle is traveling. Specifically, the travel position information may be information of the latitude and longitude of the position where the first vehicle is traveling. Alternatively, the travel position information may be information indicating a position in which the first vehicle is traveling by some relative coordinate.

The second vehicle is a vehicle that is different from the first vehicle and is traveling around the first vehicle. The second vehicle may not be limited to one but may be more than one.

The peripheral vehicle information is information about the second vehicle that the first vehicle acquires. The peripheral vehicle information includes information indicating a traveling position of the second vehicle. Further, the peripheral vehicle information may further include information or the like indicating the vehicle model or color of the second vehicle.

The road video is a video of the road taken by a camera mounted on a moving object such as a moving vehicle. Road video is preferably retained by the system for all roads on which the system is subject to providing services.

The first video is a video extracted from a wide range of road video and is a road video of a part corresponding to the traveling position of the first vehicle indicated by the travel position information.

A vehicle video is a video depicting a second vehicle, for example, a video reproducing the appearance of the second vehicle. The vehicle videos may be generated by the system based on the peripheral vehicle information. For example, when the peripheral vehicle information includes information indicating a vehicle model of the second vehicle, the system may select a vehicle image matching the vehicle model from among the plurality of vehicle images stored in advance based on the information.

The system according to one aspect of the present disclosure transmits, to the first vehicle, when visibility is poor, a road video (first video) taken in advance when visibility is good, corresponding to a traveling position at the point of the first vehicle, and a video displayed in a manner superimposed on the first video that depicts a second vehicle traveling in the vicinity (vehicle video).

By outputting the vehicle video to the first video in a superimposed manner, the first vehicle can indicate to the user the shape of the road and the position of the surrounding vehicle, which is difficult for the user to see, even if visibility is poor. This enables the system according to an aspect of the present disclosure to provide assistance to a user so as to be able to recognize surrounding vehicles even it has poor visibility, in the same way as when visibility is good.

Further, the controller may be configured to perform: when it is determined that the visibility around the first vehicle is good, acquiring, from the mobile communication terminal of the first vehicle, the road video of the road on which the first vehicle is traveling.

This enables the system according to an aspect of the present disclosure to acquire and store a road video in advance when visibility is good. The vehicle that receives the road video when visibility is poor may also function as a vehicle that provides the road video when visibility is good.

The system according to one aspect of the present disclosure may be a communication system that constitutes a core network that realizes 5G or the like or may be a communication system connected to the core network. Alternatively, the system according to one aspect of the present disclosure may be a communication system that is not connected to a cellular network that realizes 5G or the like.

Further, a vehicle according to one aspect of the present disclosure is a vehicle comprising a display and a controller comprising at least one processor configured to perform: transmitting, to a core network, travel position information that is information on a travel position of a first vehicle and peripheral vehicle information that is information on one or more second vehicles traveling around the first vehicle; acquiring, from the core network, a first video that is a video corresponding to a position indicated by the travel position information extracted from the road video captured when visibility is good and a vehicle video that is a video depicting the second vehicle and generated based on a peripheral vehicle information; and causing display unit to display the vehicle video with superimposed on the first video.

The display unit 240 is a front window of the first vehicle, or a display of an in-vehicle terminal provided by the first vehicle.

A vehicle according to an aspect of the present disclosure transmits a video of a road being traveled by the vehicle captured by the in-vehicle camera to the core network. Further, the vehicle according to an aspect of the present disclosure receives from the core network a road video taken when visibility is good and a vehicle video depicting a second vehicle traveling around the first vehicle and displays these videos in a manner in which the vehicle video is superimposed on the road video.

As a result, the vehicle according to one aspect of the present disclosure can have the same effect as the system according to one aspect of the present disclosure.

Further, the controller may be configured to perform: transmitting the first video to a mobile communication terminal of the second vehicle by vehicle-to-vehicle communication.

This enables the vehicle according to an aspect of the present disclosure to directly transmit, to the second vehicle, a road video corresponding to the traveling position at the current point among the road video taken in advance when visibility is good. Accordingly, the vehicle according to an aspect of the present disclosure may reduce a load on communication in a wireless communication network.

Further, the controller may be configured to perform: acquiring, from the second vehicle, color information that is information on color of the second vehicle; and causing the display unit to display the vehicle video in a color corresponding to the color information when displaying the vehicle video with superimposing on the first video.

This enables the vehicle according to an aspect of the present disclosure to display the vehicle video in the actual color of the second vehicle when displaying the vehicle video in a manner in which the vehicle video is superimposed on the road video. Accordingly, the vehicle according to an aspect of the present disclosure may provide a user with a video that is less uncomfortable.

Hereinafter, a specific embodiment of the present disclosure will be explained based on the drawings. The hardware configuration, module configuration, functional configuration, etc. described in each embodiment are not intended to limit the technical scope of the disclosure to only those unless otherwise stated.

### First Embodiment

### [Overview of the Processing Performed by the Server Apparatus]

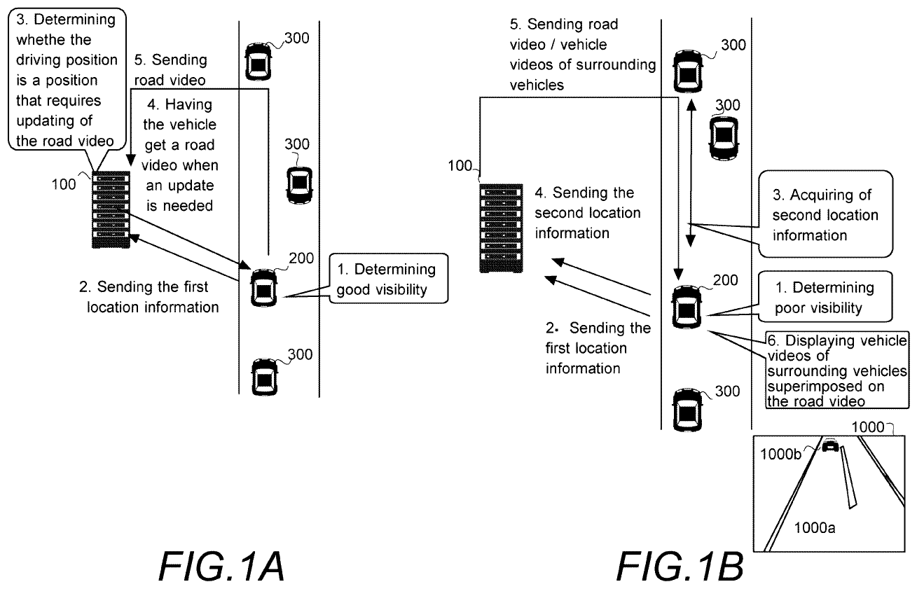

An overview of the system according to the embodiment will be explained with reference to FIG. 1A and FIG. 1B. FIG. 1A and FIG. 1B illustrates a process of acquiring a road video and a process of providing the first video and the vehicle video by the server apparatus 100 according to an aspect of the present disclosure. The system according to the present embodiment is realized as, for example, a system including a server apparatus 100. In the present embodiment, the server apparatus 100 stores a video (road video) of the traveled road for each unit section (referred to as a road segment) of the road. Further, the server apparatus 100 stores videos representing the exterior of the plurality of vehicles (vehicle videos). The server apparatus provides a road video and a vehicle video to the first vehicle using the above videos.

First, a process in which the server apparatus 100 acquires the road video from the first vehicle 200 in advance when the visibility around the first vehicle 200 is good will be explained.

FIG. 1A illustrates the processing of acquisition of road video by the server apparatus 100.

When the first vehicle 200 determines that the visibility is good during driving, the first vehicle 200 transmits information on the traveling road, the traveling position, and the traveling lane, etc. (hereinafter, first position information) to the server apparatus 100 together with information on the result of determining the visibility (hereinafter, visibility information). For example, the first vehicle 200 transmits information on the latitude and longitude of the current position during driving to the server apparatus 100.

When the server apparatus 100 receives the first position information from the first vehicle 200, which has good visibility around it, it determines whether the road segment on which the first vehicle 200 is traveling is a road segment that needs to be updated with a road video. Here, the first position information may include information indicating the traveling position of the first vehicle 200, and in addition, information indicating the road or lane on which the first vehicle 200 is traveling.

For example, when there is a road video that has not been updated for a predetermined period of time or more among the stored road video, the server apparatus 100 may determine that the road segment corresponding to the road video is a road segment that needs to be updated. Alternatively, the server apparatus 100 may determine that the road segment in which the road video is not stored is a road segment in need of updating the road video. This is because it is necessary to acquire a new road video in the road segment and add it to the database. Note that road video refers to a video of a road shot mainly by an in-vehicle camera or the like.

Next, the server apparatus 100 instructs the first vehicle 200 to acquire the road video when it determines that the traveling position of the first vehicle 200 is in the road segment that needs to be updated. The first vehicle 200 that receives the instruction transmits the road video captured in real time to the server apparatus 100. Then, the server apparatus 100 stores the received road video in association with the road segment.

In this way, the server apparatus 100 acquires and stores road video taken by the first vehicle 200 in advance when visibility around the first vehicle 200 is good.

Next, a process of providing the first video and the vehicle video to the first vehicle 200 by the server apparatus 100 when the visibility around the first vehicle 200 is poor will be explained. FIG. 1B illustrates the processing of providing the first video and the vehicle video by the server apparatus 100 according to an aspect of the present disclosure. Here, the first video refers to a road video corresponding to the road segment on which the first vehicle 200 is traveling, extracted from all the road video. Further, the vehicle video refers to a video representing the appearance of the second vehicle 300 traveling around the first vehicle 200.

When the first vehicle 200 determines that visibility is poor in the vicinity of the own vehicle, the first vehicle 200 transmits the first position information together with the visibility information to the server apparatus 100. As described above, for example, the first vehicle 200 transmits information on the latitude and longitude of the current position during driving to the server apparatus 100.

Subsequently, the first vehicle 200 acquires information (hereafter, second position information) on the traveling position of the vehicle (second vehicle 300) traveling around the subject vehicle. The second position information includes information on the vehicle model or color, etc., of the second vehicle 300 in addition to the position information of the second vehicle 300. The second position information is a specific example of “peripheral vehicle information”. Specifically, the first vehicle 200 may execute vehicle-to-vehicle communication with the second vehicle 300 to acquire the second position information. Further, the first vehicle 200 may acquire the second position information by image recognition or the like.

Next, the first vehicle 200 transmits the second position information to the server apparatus 100.

When the server apparatus 100 receives the above-mentioned information from the first vehicle 200 with poor visibility around it, it extracts the first video, which is a road video corresponding to the road segment on which the first vehicle 200 is traveling, from the previously acquired road video. Further, the server apparatus 100 generates a vehicle image that is a video depicting the exterior of the second vehicle 300 based on information on the vehicle model of the second vehicle 300 included in the second position information. The server apparatus 100 stores a plurality of vehicle videos corresponding to a plurality of vehicles (models), and videos of vehicles corresponding to the vehicle model of the second vehicle may be extracted from these.

Note that when the second position information includes information on the color of the second vehicle 300, the server apparatus 100 may extract a video of the vehicle with the corresponding color based on the information. Alternatively, the body color of the second vehicle 300 may be colored on the extracted image.

Further, instead of the server apparatus 100, the in-vehicle device or the like provided by the first vehicle 200 may color the image representing the appearance of the second vehicle 300 based on the information.

Subsequently, the server apparatus 100 transmits the first video extracted from the road video and the generated vehicle video to the first vehicle 200. The first vehicle 200, which receives the first video and the vehicle video, displays a video 1000 in which the vehicle video 1000b is superimposed on the first video 1000a on the display unit such as the front window.

As described above, the server apparatus 100 may provide the first video taken when the first vehicle 200 is in a driving environment with poor visibility and a vehicle video depicting the appearance of the second vehicle traveling around the first vehicle.

### [Configuration of Server Apparatus]

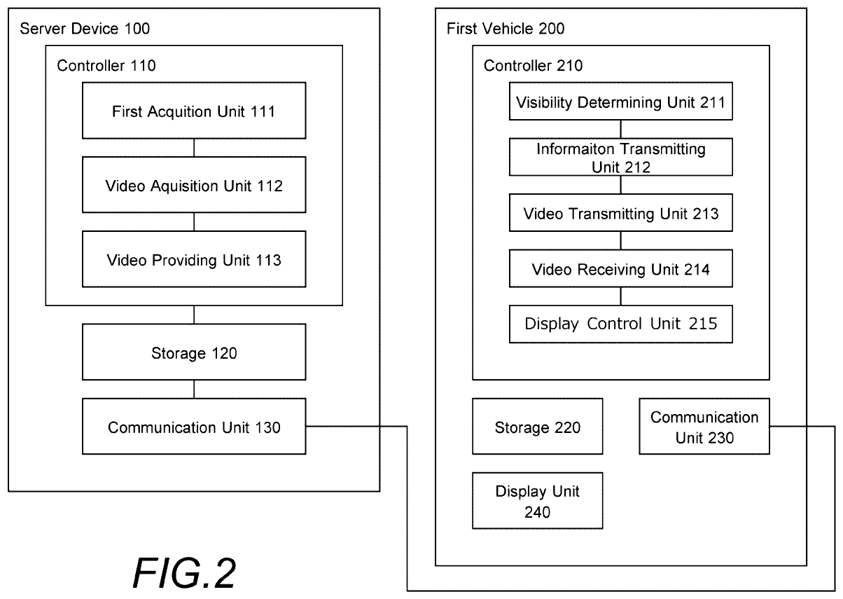

Next, the hardware configuration and software configuration of each device constituting the server apparatus 100 will be explained. FIG. 2 is a diagram illustrating the components that the server apparatus 100 and the first vehicle 200 according to the embodiment include.

The server apparatus 100 may be configured as a computer including a processor (CPU, GPU, etc.), a main storage device (RAM, ROM, etc.), and an auxiliary storage device (EPROM, hard disk drive, removable media, etc.). An operating system (OS), various programs, various tables, etc. are stored in the auxiliary storage device, and by executing the program stored therein, each function (software module) suitable for a predetermined purpose as described later can be realized. However, some or all of the functions may be realized as a hardware module by hardware circuits such as, for example, ASICs, FPGAs.

The server apparatus 100 is configured to include a controller 110, a storage 120, and a communication unit 130.

The controller 110 is realized by a processor such as the CPU (Central Processing Unit) or the GPU (Graphics Processing Unit) and storage. The controller 110 includes, as a functional module, the first acquisition unit 111, the video acquisition unit 112, and the video providing unit 113. These functional modules may be realized by executing the program by controller 110.

The first acquisition unit 111 acquires, from the first vehicle 200, view information that is information on the field of view around the first vehicle 200 and first position information. The first acquisition unit 111 further acquires second position information from the first vehicle 200 when the visibility around the first vehicle 200 is poor.

When the visibility information received by the first acquisition unit 111 indicates that the area around the first vehicle 200 has good visibility, the video acquisition unit 112 determines whether or not to receive the road video from the first vehicle 200. When the traveling position of the first vehicle 200 acquired by the first acquisition unit 111 is in a road segment that requires updating of the road video, the video acquisition unit 112 determines to receive a provision of the road video from the first vehicle 200. Then, when the video acquisition unit 112 determines that the first vehicle 200 receives the road video, the video acquisition unit 112 requests the first vehicle 200 to provide the road video and receives the road video from the first vehicle 200.

The video providing unit 113 generates a vehicle video that is a video depicting the exterior of the second vehicle 300 based on information on the vehicle model of the second vehicle 300 included in the second position information. Alternatively, the video providing unit 113 may select a video depicting the same vehicle as the second vehicle 300 from among the videos corresponding to each of the plurality of vehicle models stored in the storage 120 in advance based on information on the vehicle model. Further, the video providing unit 113 extracts the first video from all the road video. The first video refers to a road video including a road segment corresponding to the traveling position of the first vehicle 200. Here, the traveling position of the first vehicle 200 refers to the traveling position of the first vehicle 200 at that point acquired when the first acquisition unit 111 obtains information that visibility around the first vehicle 200 is poor. Then, the video providing unit 113 transmits the first video and the vehicle video to the first vehicle 200.

The storage 120 is a main storage device such as RAM and ROM, an EPROM, a hard disk drive, and an auxiliary storage device such as removable media. An operating system (OS), various programs, various tables, etc. are stored in the auxiliary storage device, and by executing the program stored therein, each function corresponding to a predetermined purpose of each part of the controller 110 may be realized. However, some or all functions may be realized by hardware circuits such as ASICs and FPGAs.

The storage 120 stores data and the like used or generated by the processing executed by the controller 110. Further, the storage 120 may store video data corresponding to each of a plurality of vehicle models to be worn when generating vehicle videos.

The communication unit 130 is composed of a communication circuit that performs wireless communication. The communication unit 130 may be, for example, a communication circuit that performs wireless communication using 4G (4th Generation) or a communication circuit that performs wireless communication using 5G (5th Generation). Further, the communication unit 130 may be a communication circuit that performs wireless communication using LTE (Long Term Evolution) and may be a communication circuit that performs communication by LPWA (Low Power Wide Area). Further, the communication unit 130 may be a communication circuit that performs wireless communication using Wi-Fi (registered trademark).

### [Configuration of the First Vehicle]

Next, the elements constituting the first vehicle 200 will be explained. The first vehicle 200 is a vehicle equipped with a mobile communication terminal and is a vehicle capable of wirelessly communicating with the core network in the other vehicle and the cellular communication network such as 5G. Here, the core network refers to a core network in a cellular communication network such as 5G that recognizes the mobile communication terminal mounted by the first vehicle 200 as a UE. The server apparatus 100 is not included in the core network but is connected to the core network. The first vehicle 200 is configured to include the controller 210, the storage 220, communication unit 230, and the display unit 240.

The controller 210 is realized by a CPU, or a processor such as a GPU, and storage. The controller 210 includes, as a functional module, a visibility determining unit 211, an information transmitting unit 212, a video transmitting unit 213, a video receiving unit 214, and a display control unit 215. These functional modules may be realized by executing the program by the controller 210.

The visibility determining unit 211 determines whether the visibility around the first vehicle 200 is good. The visibility determining unit 211 may analyze the video captured by the in-vehicle camera, or the output of the lightness-sensor provided by the first vehicle 200, and determine whether the visibility around the first vehicle 200 is good or not. The visibility determining unit 211 generates visibility information that is information indicating whether the visibility around the first vehicle 200 is good or not.

The information transmitting unit 212 acquires the first position information, which is information including the position information of the own vehicle and transmits it together with the view information generated by the visibility determining unit 211 to the server apparatus 100. Note that when the visibility determining unit 211 determines that the visibility around the first vehicle 200 is poor, the information transmitting unit 212 acquires second position information, which is information including position information of the second vehicle 300, from the second vehicle 300 by means of vehicle-to-vehicle communication, and further transmits the second position information to the server apparatus 100.

When the video transmitting unit 213 receives a request from the server apparatus 100, it acquires the road video by means of the in-vehicle camera provided by the first vehicle 200. Then, when the video transmitting unit 213 receives a request from the server apparatus 100, the video transmitting unit 213 transmits a road video captured by the in-vehicle camera of the first vehicle 200 to the server apparatus 100.

The video receiving unit 214 receives the first video and the vehicle video from the server apparatus 100. The received video is transmitted to the display control unit 215, which will be described later. Note that the video receiving unit 214 may transmit, to the second vehicle 300, the first video and the vehicle video received from the server apparatus 100 via vehicle-to-vehicle communication.

The display control unit 215 causes the display unit 240 (described later) of the first vehicle 200 to display a video in which the vehicle video is superimposed on the first video. Note that when the actual color of the second vehicle 300 is not reflected in the vehicle video received from the server apparatus 100, the display control unit 215 may color the body color of the second vehicle 300 on the vehicle video based on information on the color of the second vehicle 300 included in the second position information acquired by the information transmitting unit 212.

The storage 220 is a main storage device such as RAM or ROM, an EPROM, a hard disk drive, and an auxiliary storage device such as removable media. An operating system (OS), various programs, various tables, etc. are stored in the auxiliary storage device, and by executing the program stored therein, each function corresponding to a predetermined purpose of each part of the controller 110 may be realized. However, some or all functions may be realized by hardware circuits such as ASICs and FPGAs.

The storage 220 stores data and the like used or generated by the processing executed by the controller 210. Further, the storage 220 may temporarily store the first video received from the server apparatus 100 and the vehicle video.

The communication unit 230 is composed of a communication circuit that performs wireless communication. The communication unit 230 is a mobile communication terminal. The communication unit 230 may be, for example, a communication circuit that performs wireless communication using 4G or a communication circuit that performs wireless communication using 5G. Further, the communication unit 230 may be a communication circuit that performs wireless communication using LTE, and may be a communication circuit that performs communication by LPWA. Further, the communication unit 230 may be a communication circuit that performs wireless communication using Wi-Fi (registered trademark).

The display unit 240 is a front window of the first vehicle 200, or a display that displays an image or the like for providing information to a user. The display unit 240 may be a liquid crystal display, an organic EL (Electro-Luminescence) display. Further, the display unit 240 may be realized as a touch panel display.

### [Processing of Server Device]

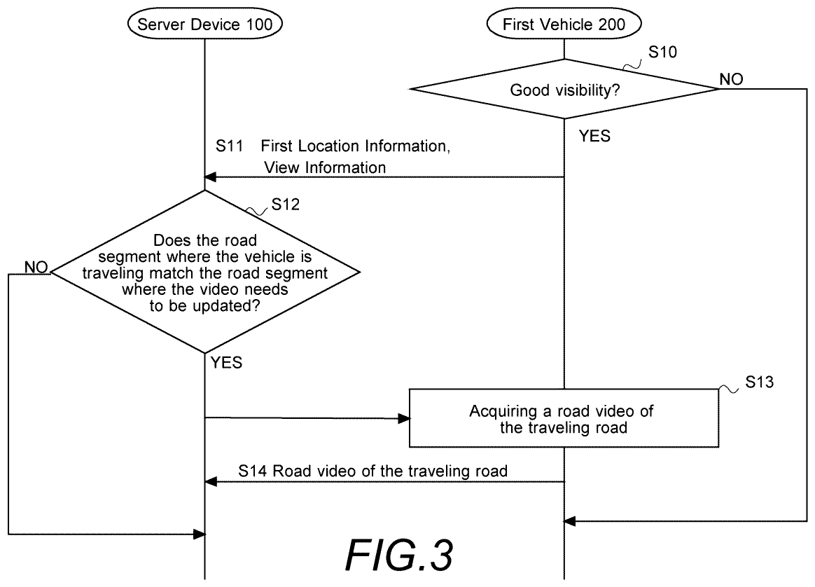

Next, a specific description of the processing executed by the server apparatus 100 will be explained. 3 is a sequence diagram of the processing of acquiring road video executed by the server apparatus 100 according to the first embodiment. The process illustrated in FIG. 3 is a process in which the server apparatus 100 acquires a video captured by the first vehicle 200.

The process illustrated in FIG. 3 is periodically executed while the first vehicle 200 is running.

First, in step S10, the visibility determining unit 211 of the first vehicle 200 determines whether the visibility around the first vehicle 200 is good or not. The visibility determining unit 211 may analyze the video captured by the in-vehicle camera mounted on the first vehicle 200 to determine whether the visibility around the first vehicle 200 is good or not. Specifically, when an image of a predetermined amount or more of the areas in the video of the in-vehicle camera is clear, the visibility determining unit 211 may determine that the visibility around the first vehicle 200 is good. Alternatively, the visibility determining unit 211 may analyze the value detected by the lightness-sensor installed in the first vehicle 200 and determine that the visibility around the first vehicle 200 is good when the value is equal to or greater than a predetermined threshold. The visibility determining unit 211 generates visibility information, that is information indicating whether the visibility around the first vehicle 200 is good or not.

Subsequently, in step S11, the information transmitting unit 212 of the first vehicle 200 transmits the first position information and the view information generated by the visibility determining unit 211 to the server apparatus 100. For example, the information transmitting unit 212 of the first vehicle 200 transmits the latitude and longitude information of the traveling position acquired by the GPS (Global positioning system) device installed in the first vehicle 200 to the server apparatus 100. Further, the information transmitting unit 212 of the first vehicle 200 may transmit information indicating the lane in which the first vehicle 200 is traveling to the server apparatus 100 recognized by the information transmitting unit 212 by analyzing an image captured by the in-vehicle camera provided by the first vehicle 200.

Next, in step S12, the first acquisition unit 111 of the server apparatus 100 determines whether the road segment on which the first vehicle 200 is traveling is a road segment that requires updating of the road video. Specifically, the first acquisition unit 111 of the server apparatus 100 determines whether the road segment that needs to be updated in the road video stored in advance is the road segment on which the first vehicle 200 is traveling. Note that, prior to the above determination, the first acquisition unit 111 of the server apparatus 100 identifies the road segment for which an update of the road video is required. In other words, the server apparatus 100 identifies a road segment corresponding to the road video that has been determined to need to be updated in the road video stored in advance. For example, the server apparatus 100 may determine that the road video that has not been updated for a predetermined period of time or more needs to be updated. Alternatively, the server apparatus 100 may identify a road segment for which the road video has not yet been acquired as a road segment for which an update (acquisition) of the road video is required.

When the first acquisition unit 111 of the server apparatus 100 determines that the road segment on which the first vehicle 200 is traveling matches the road segment that needs to be updated in the road image, this step is determined to be positive.

If a positive determination is made in this step, the process transitions to step S13.

If a negative determination is made in this step, the process is terminated.

When the process transitions to step S13, the video transmitting unit 213 of the first vehicle 200 acquires the road video of the road on which the first vehicle 200 is traveling. The video transmitting unit 213 may acquire road images of the road on which the first vehicle 200 is traveling by way of the in-vehicle camera of the first vehicle 200. The road video may be one or more fixed length video data.

Subsequently, in step S14, the video transmitting unit 213 of the first vehicle 200 transmits the road video acquired in step S15 to the server apparatus 100. The video transmitting unit 213 transmits the road video to the server apparatus 100 by way of the communication unit 230.

Then, the server apparatus 100 acquires the road video from the first vehicle 200.

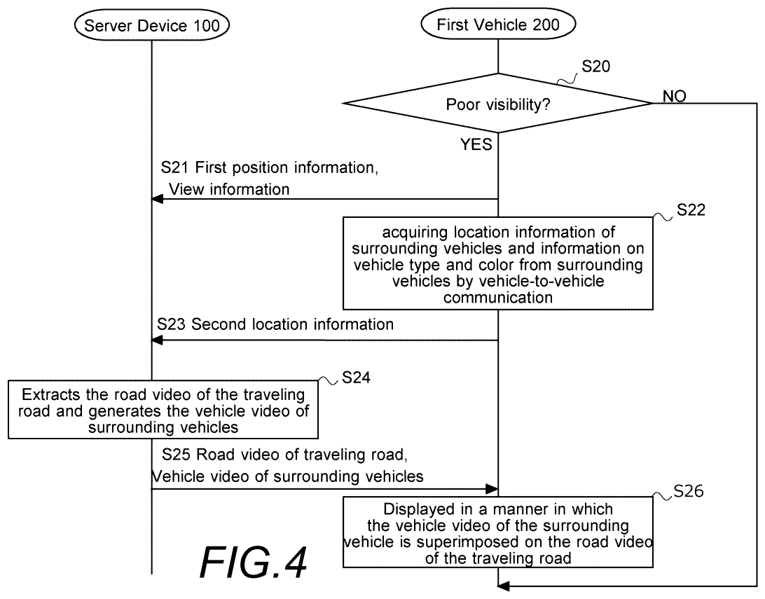

Next, the process illustrated in FIG. 4 is explained. 4 is a sequence diagram of a process of providing a road video and a vehicle video to the first vehicle 200 from the server apparatus 100 according to the first embodiment. FIG. 4 is a process in which the server apparatus 100 provides the first vehicle 200 with a video corresponding to the traveling position acquired in advance when the visibility around the first vehicle 200 is good.

The process illustrated in FIG. 4 is cyclically executed during driving of the first vehicle 200.

First, in step S20, the visibility determining unit 211 of the first vehicle 200 determines whether the visibility around the first vehicle 200 is poor. For example, the visibility determining unit 211 may determine whether the visibility around the first vehicle 200 is poor or not by analyzing an image of the in-vehicle camera mounted on the first vehicle 200. Specifically, when an image of a predetermined amount or more of the areas in the video of the in-vehicle camera is unclear, the visibility determining unit 211 may determine that the visibility around the first vehicle 200 is poor.

Alternatively, the visibility determining unit 211 may determine whether the visibility around the first vehicle 200 is poor or not based on data detected by the lightness-sensor installed in the first vehicle 200. Specifically, when the lightness around the first vehicle 200 indicated by the data detected by the lightness-sensor is less than or equal to a predetermined threshold value, the visibility determining unit 211 may determine that the visibility around the first vehicle 200 is poor. The visibility determining unit 211 generates visibility information that is information indicating whether the visibility around the first vehicle 200 is good or not.

When the visibility determining unit 211 determines that the visibility around the first vehicle 200 is poor, this step is determined to be positive.

If a positive determination is made in this step, the process transition to step S21.

If a negative determination is made in this step, the process is terminated.

When the process transitions to step S21, the information transmitting unit 212 of the first vehicle 200 transmits the first position information and the view information generated by the visibility determining unit 211 to the server apparatus 100. The information transmitting unit 212 transmits the above information to the server apparatus 100 by wireless communication via the communication unit 230 of the first vehicle 200.

Next, in step S22, the information transmitting unit 212 acquires second position information from the second vehicle 300, which is one or more vehicles traveling around the first vehicle 200, by means of vehicle-to-vehicle communication. The second position information includes information on the vehicle model or color of the second vehicle in addition to the position information of the second vehicle.

Subsequently, in step S23, the information transmitting unit 212 of the first vehicle 200 transmits the second position information acquired in step S22 to the server apparatus 100. The information transmitting unit 212 transmits the above information to the server apparatus 100 by wireless communication via the communication unit 230 of the first vehicle 200.

Next, in step S24, the video providing unit 113 of the server apparatus 100 extracts a video (referred to as the first video) of the traveling road corresponding to the road segment on which the first vehicle 200 is traveling based on the first position information received in step S21. The first video may be one or more of the ones in which the road video is divided into road segment units. Then, the video providing unit 113 of the server apparatus 100 further generates a video (referred to as the vehicle video) depicting the exterior of the second vehicle 300 based on the second position information received in step S23. In this case, if the first acquisition unit 111 of the server apparatus 100 has acquired information on the vehicle model and color of the second vehicle 300 together, the vehicle video may be generated based on the information on the vehicle model and color. The vehicle video may be still image data or video data. The vehicle video may be still image data or video data that depicts the exterior of the second vehicle 300 with a picture or a photo and is adjusted in relation to the first video.

Next, at step S25, the video providing unit 113 of the server apparatus 100 transmits the first video extracted at step S24 and the generated vehicle video to the communication unit 230 of the first vehicle 200. The video providing unit 113 of the server apparatus 100 transmits the video to the communication unit 230 of the first vehicle 200 by way of the communication unit 130 of the server apparatus 100. The video providing unit 113 may transmit the first video and the vehicle video by streaming to the communication unit 130 of the first vehicle 200. The first video and the vehicle video are received by the video receiving unit 214 of the first vehicle 200.

Next, at step S26, the display control unit 215 of the first vehicle 200 superimposes the vehicle video on the first video received by the video receiving unit 214 at step S25 and causes the display unit 240 to display it. The display control unit 215 to display the video generated by the video providing unit 113 superimposed on the vehicle video at an appropriate position of the first video extracted by the video providing unit 113, which is generated based on the traveling position of the second vehicle 300. When the video receiving unit 214 receives the first video and the vehicle video that have been streamed, the display control unit 215 may cause the received video data to be displayed sequentially on the display unit 240.

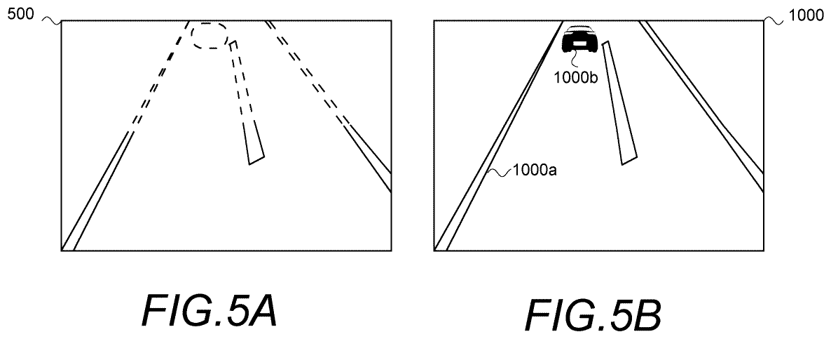

FIG. 5A and FIG. 5B are diagram illustrating an example of a field of view when visibility is poor and an example of a screen in which a vehicle video is superimposed on the road video. FIG. 5A is an example of a field of view 500 around the first vehicle 200 when the field of view around the first vehicle 200 is poor. As Illustrated by FIG. 5A, the upper half of the field of view is obscured by fog, etc. In contrast, as illustrated in FIG. 5B, the display control unit 215 causes the display unit 240 to display the video 1000 overlaid with the vehicle video 1000b representing the second vehicle 300 on the first video 1000A, which is a video of a road shot when visibility around the first vehicle 200 is good. The display unit 240 is, for example, a front window.

By doing so as described above, the server apparatus 100 may provide a video captured in advance when the visibility around the first vehicle 200 is poor and a video representing a vehicle traveling around it. As a result, the server apparatus 100 can help the first vehicle 200 to supplement the unclear view by displaying a video depicting a vehicle traveling around the first vehicle in a superimposed manner on a video taken when the visibility is good.

### Second Embodiment

In the first embodiment, the visibility determining unit 211 of the first vehicle 200 has determined whether the visibility around the first vehicle 200 is poor or not. Despite this, when the first vehicle 200 is a vehicle including a mobile communication terminal, it may also be determined by a core network in a cellular communication network such as 5G that recognizes a vehicle equipped with the mobile communication terminal as a UE (User Equipment) for good or poor visibility around the first vehicle 200. By doing so, the system according to the present disclosure can reduce the load on the processing to be executed by the first vehicle 200, which is the UE. Therefore, the second embodiment is an embodiment in which the core network determines whether the visibility around the first vehicle 200 is poor or not. In the second embodiment, the system according to the present disclosure is realized as a system 100a.

### [Configuration of Core Network Etc.]

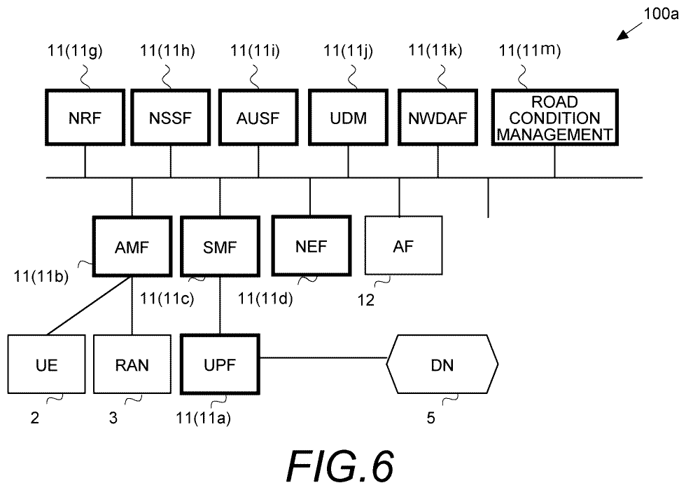

FIG. 6 illustrates the components that configure the fifth generation mobile communications system (5G network). FIG. 6, the UE 2 is a user (subscriber) terminal. RAN (Radio Access Network) 3 is an access network to the 5G core network (5GC). RAN 3 is configured by a base station (gNB). The 5G network has a 5G core network (5GC) and an access network ((R)AN), and the 5G network is connected to UE2, DN5, and AF12. Each of the NFs 11a to 11m is a function realized by executing a program by one or more computers (information processing apparatus). However, a single computer may be able to realize any two or more of NFs 11a to 11m. Each of the NFs 11a to 11m may be referred to as a network node or network component. The component illustrated in FIG. 1A and FIG. 1B realizes the system 100A as described in the embodiment.

The 5GC is composed of a collection of components include a predetermined function called NF (Network Function). In FIG. 1, the following is illustrated as the NF11 constituting the 5GC. In FIG. 1, the NF11 constituting the 5GC is illustrated in the form of a thick line, which is a thicker line than the other lines.
UPF (User Plane Function) 11a
AMF (Access and Mobility Management Function) 11b
SMF (Session Management Function) 11c
PCF (Policy Control Function) 11d
NEF (Network Exposure Function) 11e
NRF (Network Repository Function) 11g
NSSF (Network Slice Selection Function) 11h
AUSF (Authentication Server Function) 11i
UDM (Unified Data Management) 11j
NWDAF (Network Data Analytics Function) 11k
ROAD CONDITION MANAGEMENT 11m

The UPF 11A executes routing and forwarding of user packets (user-plane packets sent and received by the UE 2), packet inspection, and QoS processing.

The AMF11b is the UE's in-space accommodation device at the 5GC. The AMF 11b accommodates the RAN 3 and executes subscriber authentication control, UE2 position (mobility) management, etc.

SMF11c manages protocol data unit (PDU) sessions and controls UPF11a to implement quality of service (QOS) control and policy control. The PDU session is a virtual communication channel for exchanging data between the UE2 and the Data Network (DN) 5. DN5 is a 5GC external data network (internet, etc.).

The NEF11d serves to mediate communication between the external node and the node in the control plane.

The NRF 11 g stores and manages information on NF (e.g., AMF, SMF, UPF, etc.) in the 5 GC. The NRF 11g may reply to the inquiry source with a plurality of candidates for NF in response to an inquiry pertaining to NF that is desired to be used.

The NSSF11h include the function of selecting a network slice used by the subscriber from among the network slices generated by the network slicing. A network slice is a virtual network include specifications depending on the application.

The AUSF11i is a subscriber authentication server that executes subscriber authentication under the control of the AMF11b.

The UDM 11j retains subscriber-related information and provides subscriber information, or acquires, registers, deletes, and changes the status of the UE 2.

The NWDAF11k has the function of collecting and analyzing data from each NF11, external server, etc. NWDAF11k is an NF that provides analytical information for the network.

The ROAD CONDITION MANAGEMENT 11m acquires the position information of the pre-registered plurality of UEs 2 from the AMF 11b, and determines whether visibility around each of the registered plurality of UEs 2 is good or not based on information gathered from the UE 2, RAN 3 (base station (gNB)) and other nodes. Then, the ROAD CONDITION MANAGEMENT 11m periodically transmits the determination result of the condition of the view around the UE2 and the position information of the target UE2 to AF12. Here, the information collected from the UE 2 may be a video of an in-vehicle camera mounted by the UE 2 (first vehicle 200) or detection data of a-sensor mounted by the UE 2 or an analysis result thereof. The ROAD CONDITION MANAGEMENT 11m periodically collects information and executes the above determination.

The AF 12 transmits the first video and the vehicle video to the UE 2 when the ROAD CONDITION MANAGEMENT 11m determines that there is a UE 2 with poor visibility around the UE 2. Further, the AF 12 acquires a road video from the UE 2 when the ROAD CONDITION MANAGEMENT 11m determines that there is a UE 2 with good visibility around the UE 2.

Note that the ROAD CONDITION MANAGEMENT 11m may periodically transmit the identifier of the UE 2 that determines the visibility around the UE 2 and the determination result of the condition of the visibility around the UE 2 to the AF 12. In this case, the AF 12 receives the position information of the UE 2 from the UE 2 and obtains a determination result of a state of visibility around the UE 2 based on the identifier of the UE 2 that transmitted the position information. The AF 12 transmits the first video and the vehicle video to the UE 2 that has been determined to have poor visibility around the UE 2 when the result of determining the condition of visibility acquired by the AF 12 indicates that the surrounding area of UE2 has poor visibility. Further, the AF 12 acquires the road video from the UE 2 in which it is determined that the surroundings of the UE 2 are in good visibility when the obtained determination result indicates that the surroundings of the UE 2 are in good visibility.

Alternatively, the AF 12 may receive the position information of the UE 2 directly from the UE 2 and request the ROAD CONDITION MANAGEMENT 11m to determine a result of determining a state of visibility at a point corresponding to the position information of the UE 2. ROAD CONDITION MANAGEMENT11m sends AF12 the result of determining the status of visibility of the concerned point. In that case, the AF 12 sends the first video and the vehicle video to the UE 2 located at the point when the result of determining the state of visibility at the point is that visibility is poor at the point. Further, in a case when the result of determining the visibility state acquired by the AF 12 is that the visibility at the concerned point is good, the AF 12 acquires the road video from the UE 2 located at the concerned point.

The AF 12 is an NF that provides application services via the NRF 11g as part of the 5GC, or an NF that is external to the 5GC and provides application services via the NEF 11d. As described above, for example, the AF 12 extracts a video acquired in advance from a plurality of vehicles based on the determination result of the visibility state around the UE 2, and also generates a video representing the second vehicle 300 traveling around the UE 2 and transmits both to the UE 2.

As an example, the AF 12 executes the following actions when the ROAD CONDITION MANAGEMENT 11m transmits a result of determining that visibility around the UE 2 is good. The AF 12 receives, from the UE 2, third position information that is information on the traveling position of the UE 2. Note that the third position information may include information on a road on which the UE 2 is traveling, or information on a lane on which the UE 2 is traveling. Then, the AF 12 determines whether the traveling position of the first vehicle 200 indicated by the third position information is included in the road segment that requires updating of the road video. If the AF 12 determines that the traveling position of the first vehicle 200 is included in the road segment for which it is necessary to update the road video, the AF 12 instructs the UE 2 to shoot the road video and send it to the AF 12. The AF 12 then receives and stores the road video captured by the UE 2 in real time at the driving position.

Further, as an example, the AF 12 executes the following actions when the ROAD CONDITION MANAGEMENT 11m transmits a result of determining that visibility around the UE 2 is poor. The AF 12 receives, from the UE 2, fourth position information that is information on a traveling position of the one or more second vehicle(s) 300 traveling around the UE 2. The fourth position information may include information on the road on which the second vehicle 300 is traveling, information on the lane in which the second vehicle 300 is traveling, and information on the vehicle model or color of the second vehicle 300. The AF 12 then extracts a road video (first video) corresponding to the traveling position of the first vehicle 200. The AF 12 then generates a video depicting the one or more second vehicle(s) 300 traveling around the first vehicle 200 according to the traveling position of the second vehicle 300 and the vehicle model, color, etc. included in the fourth position information, and transmits both to the first vehicle. The AF 12 may store road images acquired from the UE 2 (first vehicle 200) in advance. The fourth position information is transmitted from the first vehicle 200 to the server apparatus 100.

In 5GC, multiple NFs of the same type may be prepared. For example, NF 11 may be provided for each data center (post office). Further, in some cases, one NF 11 may be shared between data centers. Further, in some cases, a single data center may constitute multiple NFs of the same type. The number of data centers and the number of NFs 11 may be set according to the correspondence between NFs 11 and the data centers.

### Operation

First, the ROAD CONDITION MANAGEMENT 11m determines the visibility of the UE (first vehicle 200). The ROAD CONDITION MANAGEMENT 11m determines, for example, a visibility state around the UE 2 for a plurality of pre-registered UEs. At the same time, the AF 12 identifies a position on the road corresponding to the road video that needs to be updated among the road video acquired in advance. Next, the AF 12 acquires third position information, which is information on the traveling position of the UE 2, from the plurality of UEs 2 registered in advance, and determines whether the traveling position of the UE 2 is included in a road segment in which it is necessary to update the road video. If the AF 12 determines that the driving position of the UE 2 is included in the road segment where it is necessary to update the road video, it determines whether the determination result of the condition of visibility around the UE 2 pushed from the ROAD CONDITION MANAGEMENT 11m indicates that visibility is good. When the determination result of the visibility condition around the UE 2 indicates that the visibility is good, the AF 12 acquires a video (road video) of the traveling road captured by the in-vehicle camera of the UE 2 from the UE 2.

When the determination result of the visibility condition around the UE 2 determined by the ROAD CONDITION MANAGEMENT 11m indicates that the visibility is poor, the AF 12 acquires the third position information and the fourth position information from the UE 2. The AF 12 then extracts a road video (first video) corresponding to the road segment in which the traveling position of the UE 2 is included and generates a video (vehicle video) depicting the exterior of the second vehicle 300 based on the fourth position information. The generated vehicle video may reflect information on the vehicle model or color of the second vehicle 300 included in the fourth position information. Subsequently, the AF 12 transmits the first video and the vehicle video to the mobile communication terminal of the UE 2.

The UE 2 receiving the first video and the vehicle video from the AF 12 causes the display unit to display, based on the traveling position of the second vehicle 300 acquired from the second vehicle 300, a video in which the vehicle video is superimposed at an appropriate position in the first video.

By doing so as described above, the AF 12 connected to the core network in the cellular communication network such as 5G acquires a road video taken by the vehicle in advance when visibility around the UE 2 is good based on information from the core network. Then, based on the information from the core network, the AF 12 provides a first video corresponding to a road segment including a traveling position of the vehicle and a video depicting a vehicle traveling in the vicinity among the road video acquired in advance when visibility around the UE 2 becomes poor. This enables the UE 2 to assist the user in recognizing surrounding vehicles in the same way as when visibility around the UE 2 is poor.

### Other Modifications

The above embodiment is an example only, and the present disclosure may be implemented with appropriate modifications within a certain range that does not deviate from the abstract. For example, the processes and means described in the present disclosure can be freely combined and implemented as long as there is no technical contradiction.

The present disclosure may also be realized by supplying a computer program that implements the functions described in the above embodiment to a computer and includes one or more processors of the computer read and execute the program. Such computer programs may be provided to the computer by a non-transitory computer-readable storage medium connectable to the system bus of the computer or may be provided to the computer over a network. The non-transitory computer-readable storage medium includes, for example, any type of disk such as magnetic disk (Floppy® disk, hard disk drive (HDD), etc.), optical disk (CD-ROM, DVD disk, Blu-ray disk, etc.), read-only memory (ROM), random access memory (RAM), EPROM, EEPROM, magnetic card, flash memory, optical card, any type of medium suitable for storing electronic instructions.

What is claimed is:

1. A system comprising a controller comprising at least one processor configured to perform:
when it is determined that visibility around a first vehicle is poor, acquiring, from a mobile communication terminal of the first vehicle, travel position information indicating a position in which the first vehicle is traveling and peripheral vehicle information that is information on one or more second vehicles traveling around the first vehicle;
extracting a first video that is a video that corresponds to a position indicated by the travel position information among road video captured when the visibility is good that have been acquired in advance; and
transmitting the extracted first video and a vehicle video that is superimposed on the first video and is a video depicting the second vehicle generated based on peripheral vehicle information to the mobile communication terminal of the first vehicle.

2. The system of claim 1, wherein the controller is configured to perform:
when it is determined that the visibility around the first vehicle is good, acquiring, from the mobile communication terminal of the first vehicle, the road video of the road on which the first vehicle is traveling.

3. A vehicle comprising a display and a controller comprising at least one processor configured to perform:
transmitting, to a core network, travel position information that is information on a travel position of a first vehicle and peripheral vehicle information that is information on one or more second vehicles traveling around the first vehicle;
acquiring, from core network, a first video that is a video corresponding to a position indicated by the travel position information extracted from road video captured when visibility is good and a vehicle video that is a video depicting the second vehicle and generated based on a peripheral vehicle information; and
causing display unit to display the vehicle video with superimposed on the first video.

4. The vehicle according to claim 3, wherein the controller is configured to perform:
transmitting the first video to a mobile communication terminal of the second vehicle by vehicle-to-vehicle communication.

5. The vehicle according to claim 3, wherein the controller is configured to perform:
acquiring, from the second vehicle, color information that is information on color of the second vehicle; and
causing the display unit to display the vehicle video in a color corresponding to the color information when displaying the vehicle video with superimposing on the first video.
